(19) United States
(12) Patent Application Publication
(10) Pub. No.: US 2010/0109871 A1
(43) Pub. Date: May 6, 2010

(54) RFID SYSTEM AND METHOD FOR THE SAME

(75) Inventors: Lynn Ann Derose, Gloversville, NY (US); Joseph James Salvo, Schenectady, NY (US); Douglas Roy Forman, Niskayuna, NY (US); Janet Sue Bennett, Scotia, NY (US); Brandon Stephen Good, Schenectady, NY (US); Morgan Fredric Intrator, New York, NY (US); Nicolas Auguste Constant Schieli, Bietigheim-Bissingen (DE)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/262,258

(22) Filed: Oct. 31, 2008

(51) Int. Cl. G08B 13/14

(52) U.S. Cl. 340/572.7

(57) ABSTRACT

A system for a radio frequency identification tag of a radio frequency identification system, comprises an antenna mounted on a respective unit of equipment and a power supply electrically coupled to the antenna. The antenna is configured to energize a radio frequency identification tag without contact for enhancing read range of the radio frequency identification tag.

### BACKGROUND

The subject matter disclosed herein relates generally to radio frequency identification (RFID) systems, and, more particularly, to a standalone antenna for a low frequency asset-tracking RFID system to enhance read ranges of passive RFID tags.

Identifying and tracking assets is a significant expense for a business that handles significant volumes of inventory. For example, inventory items that are brought to a storage facility must be identified, categorized and stored so that the items can be readily retrievable. Inventory items that are to be shipped from storage must again be identified to provide an accurate accounting of items remaining in storage. Additionally, entire inventories may need to be periodically re-counted to ensure that accounted inventory levels remain accurate over time despite occasional human error. Consequently, several man-hours of labor may be consumed solely in asset tracking. Similarly, in shipping applications, large quantities of different items may need to be counted, listed, checked, and manifests or declarations may need to be generated for the shipper, receiver, and customs authorities.

Radio frequency identification systems decrease the cost of asset tracking. An RFID system commonly includes an RF tag and an RF tag reader. An RF tag is capable of carrying a small amount of identification data related to an item to which it is attached. The tag may be either an active tag or a passive tag. In the case of a passive tag, the tag reader transmits an RF signal to a passive tag to identify an item. The RF signal energizes the passive tag, inducing the passive tag to transmit a return signal that carries the identification information embedded on the tag. By automating most of the asset tracking process, RFID technology provides a quicker, more accurate and less expensive method of tracking assets.

Items in the inventories are retrieved by a variety of industrial transport equipment such as a clamp-lift truck and forklift truck. There are many moving parts in industrial transport equipment such as lines, hoses, hydraulics for forks, and slip rings for clamps. When the transport equipment is used to retrieve an item, the moving parts of the transport equipment interfere with the read range of a passive tag attached to the item to be retrieved. This decreases the read range of the passive tag. The passive tag therefore may not be able to capture the RF signal from the tag reader, causing difficulty in tracking the items to be retrieved.

An ultra high frequency RFID system is generally employed to overcome the aforementioned issues in tracking the items. An ultra high frequency RFID system requires wiring of readers and antennas, and may even require several layers of antennas to capture all the items. However, wired configuration of the ultra high frequency RFID system is unable to get around moving parts of the industrial transport equipments.

Therefore, it would be advantageous to provide an improved RFID system that addresses the foregoing issues.

### BRIEF DESCRIPTION

In accordance with one embodiment disclosed herein, a system for a radio frequency identification tag of a radio frequency identification system includes an antenna mounted on a respective piece of equipment and a power supply electrically coupled to the antenna. The antenna is configured to energize a radio frequency identification tag without contact for enhancing the read range of the radio frequency identification tag.

In accordance with another embodiment disclosed herein, an asset-tracking radio frequency identification system comprises radio frequency identification tags associated with assets, a radio frequency identification reader, an antenna mounted on a respective piece of equipment, and a power supply electrically coupled to the antenna. The antenna is configured to energize the radio frequency identification tags without contact for enhancing read range of the radio frequency identification tag.

In accordance with another embodiment disclosed herein, a method of enhancing read range of radio frequency identification tags of an asset-tracking radio frequency identification system comprises providing an antenna on equipment to energize a radio frequency identification tag without contact and providing a power supply electrically coupled to the antenna.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram of an asset-tracking radio frequency identification (RFID) system.

FIG. 2 illustrates a system for enhancing read range of RFID tags employed in an asset-tracking RFID system in accordance with aspects disclosed herein.

FIG. 3 illustrates an antenna with external power supply in accordance with aspects disclosed herein.

FIG. 4 illustrates a battery-powered antenna in accordance with aspects disclosed herein.

FIG. 5 illustrates a side view of a forklift truck with a system for enhancing read range of RFID tags in accordance with aspects disclosed herein.

FIG. 6 illustrates a side view of a clamp-lift truck with a system for enhancing read range of RFID tags in accordance with aspects disclosed herein.

FIG. 7 is a flowchart illustrating a method of enhancing read range of radio frequency identification tags of an asset-tracking radio frequency identification system in accordance with aspects disclosed herein.

### DETAILED DESCRIPTION

Embodiments disclosed herein include a system and method for enhancing the read range of radio frequency identification (RFID) tags of an asset-tracking RFID system. The system includes an antenna mounted on a respective piece of equipment and a power supply for the antenna. The antenna energizes RFID tags without contact to enhance the read range of the tags. The system employed enhances the read range between about two units to five units. The system may be employed in various RFID applications such as, but not limited to, RFID systems used in transport facilities, shop facilities, and shipping applications or in any other environment that encounters similar interference conditions. As used herein, the term ‘read range’ of a tag is the distance from the tag over which the tag can draw enough energy from the reader to energize the tag.

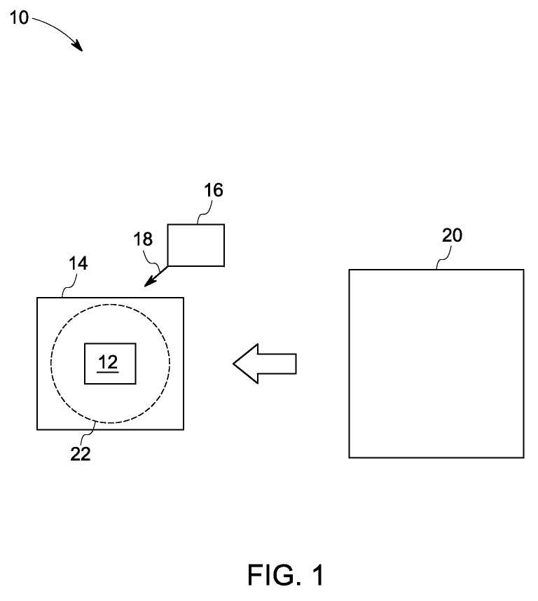

FIG. 1 illustrates a typical asset-tracking RFID system 10 including passive RFID tags 12. The passive RFID tags 12 are attached to assets 14 to be tracked in a warehouse. An RFID reader 16 transmits an RF signal 18 to a passive tag to identify an asset. The RF signal energizes the passive tag and induces the passive tag to transmit a return signal that carries the identification information embedded on the tag. Assets are tracked by this return signal and are then retrieved and hauled around the warehouse. Based on the assets' size, shape and other handling requirements, appropriate pieces of equipment are used for retrieving and hauling the assets. In one embodiment, the equipment includes industrial transport equipment 20 such as a forklift truck or a clamp-lift truck, that are typically used to retrieve and haul assets in a warehouse.

The passive RF tags 12 typically include a read range 22. In order to energize the tag 12, it is desirable that the tag's read range 22 be within the range of the RF signal 18 from the reader 16 to draw enough energy. However, several factors affect the tag's read range 22. For example, the industrial transport equipment 20, especially, the movable parts of the industrial transport equipment such as lines, hoses, hydraulics for forks and slip rings for clamps may interfere with the read range 22 of the tag 12 by obstructing the tag's read range 22. In addition, assets 14 themselves may interfere with the read range of the tag by obstructing and affecting the tag's read range. As a result, the read range 22 of the tag is decreased and the tag 12 may not be able to capture the RF signal 18, causing difficulty in tracking the asset 14.

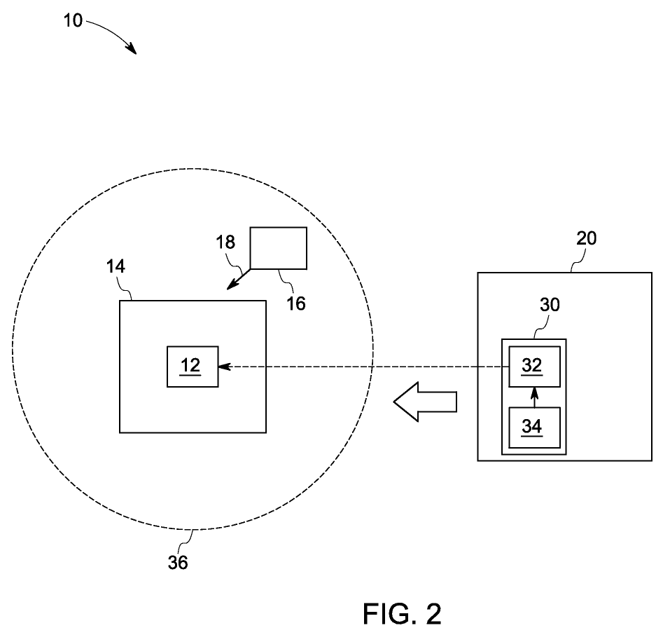

FIG. 2 illustrates a system 30 for enhancing the read range of RFID tags employed in an asset-tracking RFID system 10. The system 30 is a standalone unit and comprises an antenna 32 and a power supply 34 electrically coupled to the antenna 32. The antenna 32 is mounted on the equipment, for example the industrial transport equipment 20. The system can also be built into the equipment. In another embodiment, the system 30 can be employed with robotics used for moving assets in warehouses. The antenna 32 is configured to energize RFID tags 12 without contact by inductive coupling. When the industrial transport equipment 20 approaches an asset 14, the antenna 32 energizes the tag 12 attached to the asset 14. This will enhance the read range of the tag. The enhanced read range 36 of the tag 12 increases the probability for the RF signal 18 from the reader 16 to be transmitted to the tag 12 for drawing enough energy. Since the antenna 32 energizes the tag 12, the RF signal 18 from the reader is dedicated to induce the tag 12 to transmit a return signal without the need for the RF signal 18 to energize the tag 12. The enhanced read range 36 therefore facilitates in overcoming interference caused by the asset 14 or the movable parts of the industrial transport equipment 20.

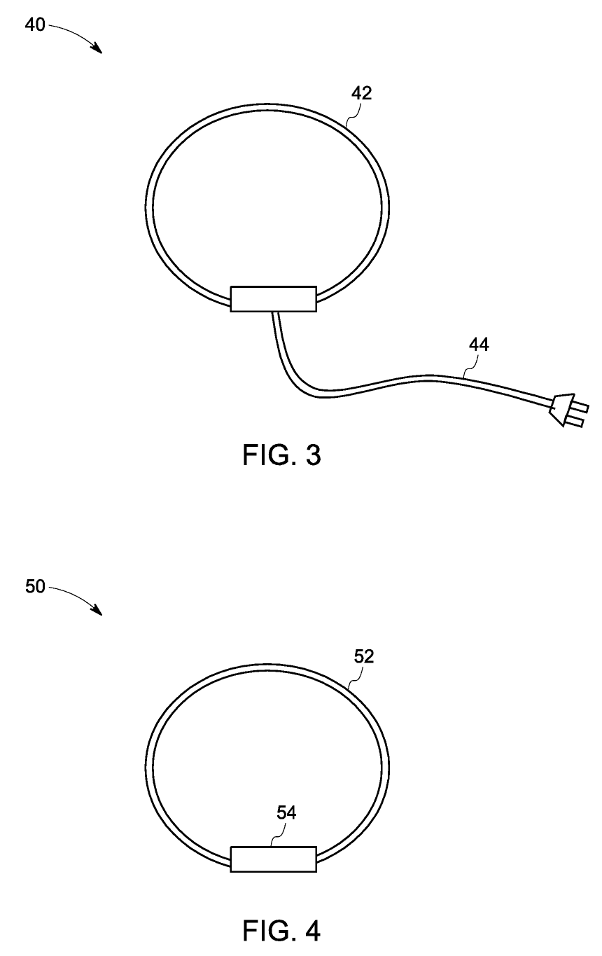

FIG. 3 illustrates an embodiment 40 of a system for enhancing read range of RFID tags. The system 40 comprises an antenna 42 including a loop structure and a power cord 44 connected to the antenna 42 for providing power supply. The power cord 44 can be plugged to a power outlet in a forklift truck or a clamp-lift truck to provide power supply to the antenna. While FIG. 3 depicts a power cord with a plug end, other embodiments can be directly wired into the power generation system or battery of the piece of equipment.

FIG. 4 illustrates another embodiment 50 of a system for enhancing read range of RFID tags. The system 50 comprises an antenna 52 including a loop structure and a built-in power supply. In one embodiment, the built-in power supply comprises a battery or batteries 54, or other energy source.

The loop structures of the antennas 42 and 52, as shown in FIGS. 3 and 4, enable the system to be mounted at several locations on the industrial transport equipment without interfering with the movable parts of the industrial transport equipment. For example, the system can be mounted on the clamp of a clamp-lift truck without interfering with slip rings or hydraulics. The systems 40 and 50 of FIGS. 3 and 4 therefore eliminate any need to redesign any part of the industrial transport equipment.

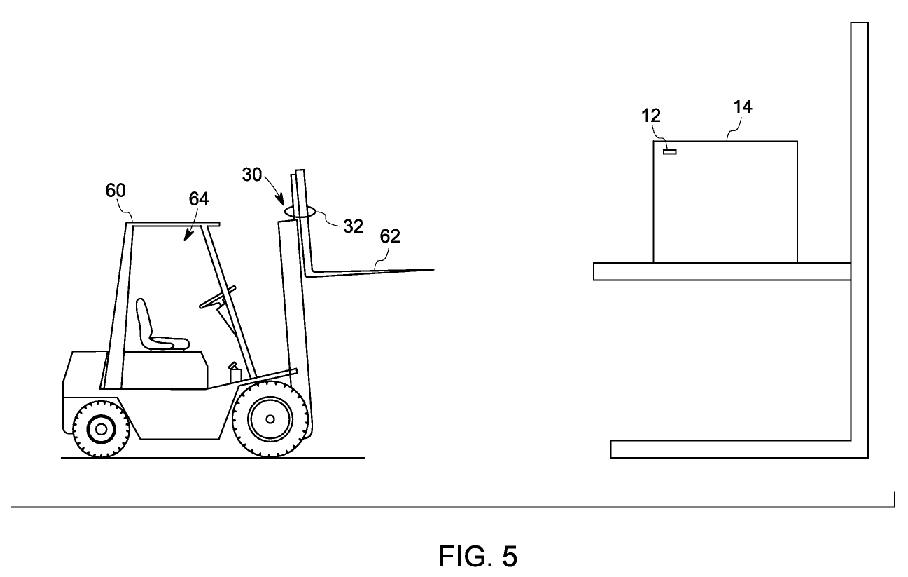

FIG. 5 illustrates a forklift truck 60 with the system 30 for enhancing the read range of passive tag 12 attached to asset 14. The antenna 32 is mounted to the exterior of the forklift truck 60, preferably near the fork 62. The reader (not shown) can be placed in the driver cabin 64 of the forklift truck 60. As discussed earlier, the loop structure of the antenna enables it to be mounted at several locations on the forklift truck. For example, the antenna 32 can be mounted on the fork 62 or on any projecting feature on the forklift truck. During the process of retrieving an asset 14, the movable parts of the forklift truck, such as the fork and other hydraulics (not shown), or the asset itself may interfere with the read range of the tag. But the antenna 32 energizes the tag 12 attached to the asset 14 to enhance the read range of the tag, overcoming any interference.

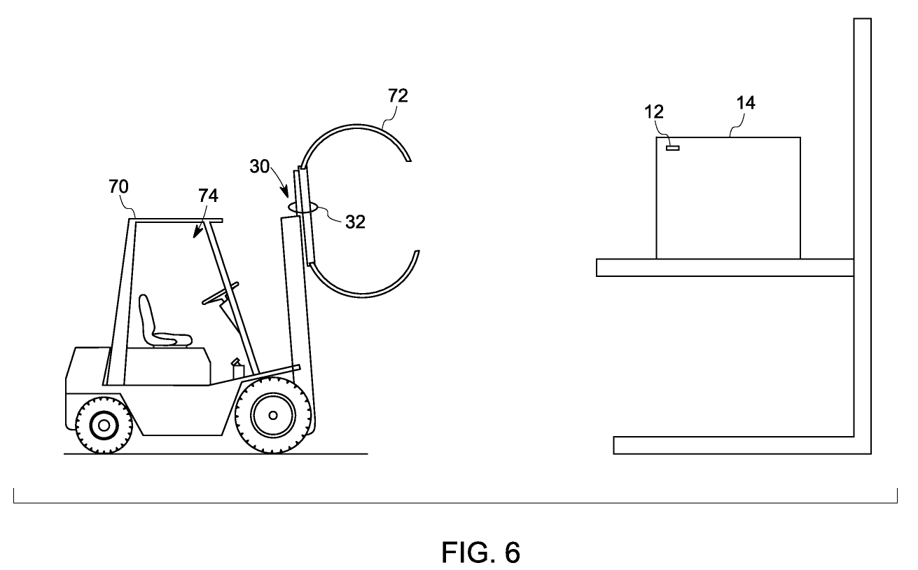

FIG. 6 illustrates a clamp-lift truck 70 with the system 30 for enhancing the read range. The reader (not shown) can be placed in the driver cabin 74 of the clamp-lift truck 70. The antenna 32 can be mounted at several locations on the clamp-lift truck 70 such as on the clamp 72 or any projecting feature of the clamp lift truck. The clamp-lift truck comprises movable parts such as the clamp 72, slip rings (not shown) and other hydraulics. The process of retrieving an asset 14 with the clamp-lift truck comprises raising or lowering the clamp 72, rotation of the clamp 72 depending on the orientation of the asset and clamping the asset. The movements of the clamp 72 and other hydraulics or the asset 14 itself may interfere with the read range of the tag 12 and decrease the read range of the tag 12. Employing the system 30 with the clamp-lift truck 70 facilitates in overcoming such interference because the antenna 32 energizes the tag 12 attached to the asset 14 to enhance the read range of the tag 18.

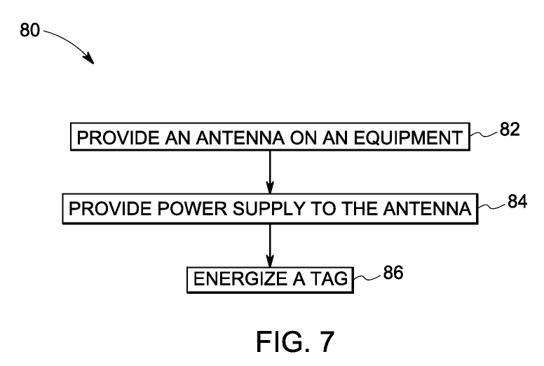

FIG. 7 illustrates a flowchart of a method 80 of enhancing read range of radio frequency identification tags of an asset-tracking radio frequency identification system. The method 80 comprises providing an antenna on a respective unit of equipment in step 82 and providing a power supply to the antenna in step 84. The antenna is mounted on a respective unit of equipment. In one embodiment, the equipment comprises industrial transport equipment such as a forklift truck or a clamp-lift truck. As discussed above, the antenna includes a loop structure and can be mounted at several locations on the industrial transport equipment. In one embodiment, the power supply is provided to the antenna from the industrial transport equipment. In another embodiment, the power supply includes batteries. In step 86, the antenna energizes an RFID tag attached to an asset when the industrial transport equipment is in the process of retrieving the asset.

The various embodiments of a system and method for an asset-tracking RFID system described above thus provide a way to enhance the read range of RFID tags. The system and method increase reliability of a reader and facilitate in overcoming interference caused by assets or movable parts of industrial transport equipment that are used to haul assets.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for a radio frequency identification tag of a radio frequency identification system, comprising:
an antenna mounted on a respective unit of equipment and configured to energize a radio frequency identification tag without contact for enhancing read range of the radio frequency identification tag; and
a power supply electrically coupled to the antenna.

2. The system of claim 1, wherein the equipment comprises industrial transport equipment.

3. The system of claim 2, wherein the industrial transport equipment comprises a forklift truck and a clamp-lift truck.

4. The system of claim 3, wherein the power supply for the antenna is provided from the forklift truck or the clamp-lift truck.

5. The system of claim 1, wherein the antenna energizes the tag by inductive coupling.

6. The system of claim 1, wherein the power supply comprises batteries.

7. The system of claim 1, wherein the antenna comprises a loop structure.

8. The system of claim 1, wherein the antenna facilitates in overcoming interference caused by the equipment.

9. An asset-tracking radio frequency identification system, comprising:
radio frequency identification tags associated with assets;
a radio frequency identification reader;
an antenna mounted on a respective unit of equipment and configured to energize the radio frequency identification tags without contact for enhancing read range of the radio frequency identification tag; and
a power supply electrically coupled to the antenna.

10. The system of claim 9, wherein the equipment comprises a forklift truck and a clamp-lift truck.

11. The system of claim 10, wherein the power supply for the antenna is provided from the forklift truck or the clamp-lift truck.

12. The system of claim 9, wherein the power supply comprises batteries.

13. The system of claim 9, wherein the antenna comprises a loop structure.

14. The system of claim 9, wherein the antenna energizes the tag by inductive coupling.

15. The system of claim 9, wherein the antenna facilitates in overcoming interference caused by the equipment.

16. A method for enhancing read range of radio frequency identification tags of an asset-tracking radio frequency identification system, comprising:
providing an antenna on an equipment to energize a tag without contact; and
providing a power supply electrically coupled to the antenna.

17. The method of claim 16, wherein providing the antenna on the equipment comprises mounting the antenna on the equipment.

18. The method of claim 17, wherein mounting the antenna on the equipment comprises mounting the antenna on an industrial transport equipment.

19. The method of claim 18, wherein mounting the antenna on the industrial transport equipment comprises mounting the antenna on a forklift truck and a clamp-lift truck.

20. The method of claim 16, wherein providing the power supply to the antenna comprises providing the power supply to the antenna from the industrial transport equipment.
